(19) United States
(12) Patent Application Publication
(10) Pub. No.: US 2024/0057662 A1
(43) Pub. Date: Feb. 22, 2024

(54) MAGNETIC BAND FOR SMOKING DEVICE

(71) Applicant: Brian Rains, Upland, CA (US)

(72) Inventor: Brian Rains, Upland, CA (US)

(21) Appl. No.: 18/260,213

(22) PCT Filed: Jan. 10, 2022
(86) PCT No.: PCT/US2022/011817

§ 371 Date: Jun. 30, 2023

Related U.S. Application Data
(60) Provisional application No. 63/135,371, filed on Jan. 8, 2021.

(51) Int. Cl. A24F 9/00; A24F 3/02

(52) U.S. Cl. CPC A24F 9/00; A24F 3/02

(57) ABSTRACT

A magnetic band for smoking device is presented. The magnetic band for smoking device contains a band body, at least one mounting platform, at least one magnet aperture, at least one magnet cavity, and at least one magnet insert. The band body contains an interior surface and an exterior surface. The at least one mounting platform is positioned adjacent to the exterior surface. The at least one mounting platform is distributed about the exterior surface of the band body. Each of the at least one magnet cavity is positioned within each of the at least one mounting platform. Each of the at least one magnet aperture traverses from the band body to each of the at least one magnet cavity. Each of the at least one magnet insert is positioned within each of the at least one magnet cavity.

### FIELD OF THE INVENTION

The present invention relates generally to accessory holding devices, specifically accessory holding devices for smoking devices.

### BACKGROUND OF THE INVENTION

In the smoking of organic materials including some rare and expensive tobaccos, it is found that inhaled smoke oftentimes tends to be somewhat harsh, hot and irritating to the lungs of a smoker. Accordingly, it is desirable that the smoke from these materials be tempered and treated prior to its being inhaled. Devices known as water pipes and/or vaporizers have been used to effect tempering and treatment of smoke.

A water pipe ordinarily includes an upstanding housing which defines a water chamber near its base. A burning bowl is operably connected to the housing for introducing smoke into the water chamber. A mouthpiece communicates with the water chamber for drawing smoke from the burning bowl through the water chamber. As the smoke travels through the water, it tends to be cleaned of ash and certain other contaminants and may be cooled slightly to render it more suitable for inhaling.

These water pipes are oftentimes paired with utensils and lighter accessories. In a conventional instance, a user will carry these accessories separately which requires that the accessories be placed on a secondary surface which may be disadvantageous as this may lead to the possibility of contamination or misplacement of these accessories. Therefore, it is an objective of the present invention to provide a means to hold these accessories along the water pipe.

### SUMMARY OF THE INVENTION

The present invention is a magnetic band for smoking device suitable for attaching along a water pipe, vaporizer, or any other suitable smoking device such that the present invention facilitates a mounting implement along the smoking device to magnetically attach a lighter, smoking device utensil, or any other suitable smoking device accessory along the present invention. The magnetic band for smoking device comprises a band body, at least one mounting platform, at least one magnet aperture, at least one magnet cavity, and at least one magnet insert. The band body comprises an interior surface and an exterior surface. The at least one mounting platform is positioned adjacent to the exterior surface. The at least one mounting platform is distributed about the exterior surface of the band body. Each of the at least one magnet cavity is positioned within each of the at least one mounting platform. Each of the at least one magnet aperture traverses from the band body to each of the at least one magnet cavity. Each of the at least one magnet insert is positioned within each of the at least one magnet cavity, where each of the at least one magnet insert is configured to slip through each of the at least one magnet aperture and install along each of the at least one magnet cavity.

### BRIEF DESCRIPTION OF THE DRAWINGS

FIG. 1 is a side view of the present invention installed along a water pipe.

FIG. 2 is a perspective view of the present invention with a cross-sectional internal cut.

FIG. 3 is a top view of the present invention.

FIG. 4 is a cross-sectional view of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

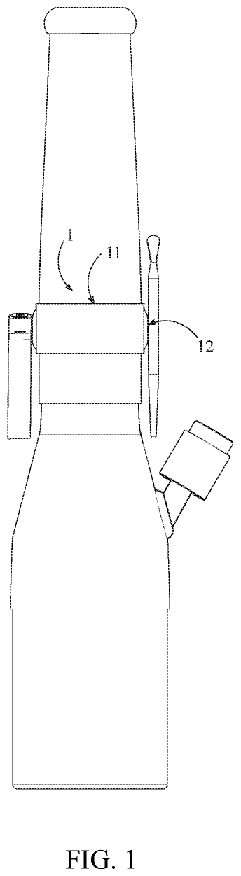

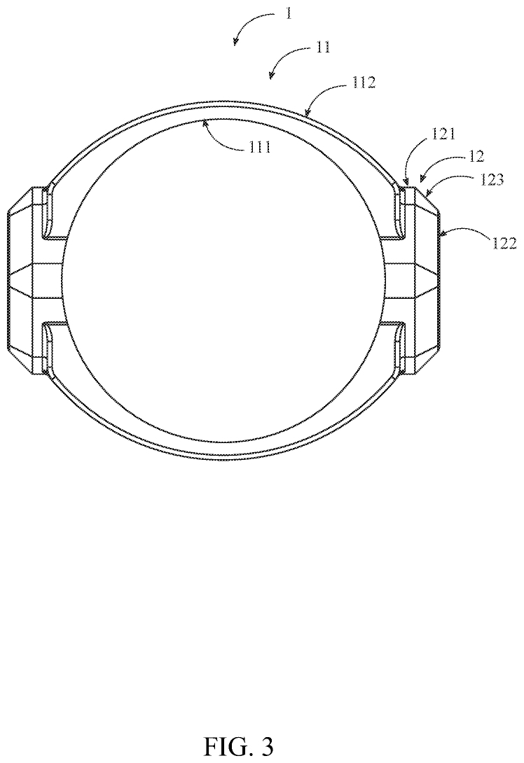

In reference to FIG. 1, the present invention is a magnetic band for smoking device 1 suitable for attaching along a water pipe, vaporizer, or any other suitable smoking device such that the present invention facilitates a mounting implement along the smoking device to magnetically attach a lighter, smoking device utensil, or any other suitable smoking device accessory along the present invention. In reference to FIGS. 1-4, the magnetic band for smoking device comprises a band body 11, at least one mounting platform 12, at least one magnet aperture 13, at least one magnet cavity 14, and at least one magnet insert 15. The band body 11 comprises an interior surface 111 and an exterior surface 112. The at least one mounting platform 12 is positioned adjacent to the exterior surface 112. The at least one mounting platform 12 is distributed about the exterior surface 112 of the band body 11. Each of the at least one magnet cavity 14 is positioned within each of the at least one mounting platform 12. Each of the at least one magnet aperture 13 traverses from the band body 11 to each of the at least one magnet cavity 14. Each of the at least one magnet insert 15 is positioned within each of the at least one magnet cavity 14, where each of the at least one magnet insert 15 is configured to slip through each of the at least one magnet aperture 13 and install along each of the at least one magnet cavity 14.

In the preferred embodiment, the band body 11 takes the form of a cylindrical ring-like shape that allows the user to mount the present invention along the shaft, neck, handle, or any other suitable body of the smoking device. In the preferred embodiment, the at least one mounting platform 12 serves as the mounting area along the band body 11 that constitutes the accessory mounting components of present invention. In the preferred embodiment, the present invention further comprises at least one indicium, where the at least one indicium is distributed about the at least one mounting platform 12 or along the band body 11. The at least one indicium takes the form of any suitable ornamental design, such as, but not limited to brand logo's, icons, symbols, or any other ornamental design that complements the overall ornamental design of the present invention. Additionally, the at least one indicium may take the form of any suitable ornamental design that visually designates the at least one mounting platform 12, allowing the user to easily spot and identify the at least one mounting platform 12 along the band body 11. In the preferred embodiment, each of the at least one magnet aperture 13 traverses from the interior surface 111 to each of the at least one magnet cavity 14. In the preferred embodiment, the at least one magnet aperture 13 takes the form of an installment aperture that allows the at least one magnet insert 15 to slip from the interior surface 111 of the band body 11 to the at least one magnet cavity 14. In conventional means, magnets are often embedded or integrated along the band body 11 during the molding process to form a magnetic band body 11. This is not preferable as the heat often associated with molding process will weaken the magnetic power of the magnets.

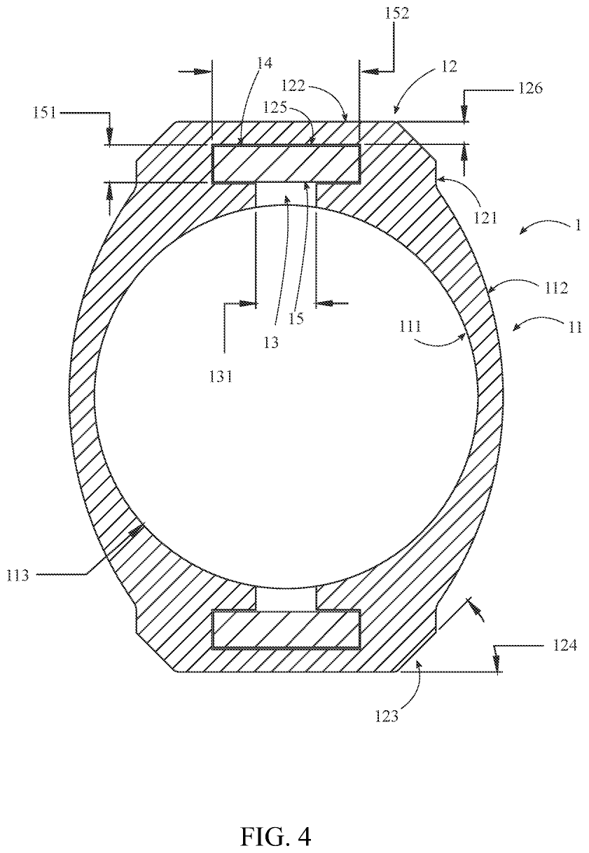

In the preferred embodiment, the band body 11 and the at least one mounting platform 12 are made out of an elastic material that comprises a specified durometer hardness ranging from 30 to 50 shore A hardness. In the preferred embodiment, the band body 11 and the at least one mounting platform 12 are made out of silicone, but may be made of any other suitable material, such as but not limited to isoprene, neoprene, or any other suitable material. In reference to FIG. 4, the interior surface 111 comprises a specified band inner diameter 113 ranging from 20 to 45 millimeters. In the preferred embodiment, the at least one magnet aperture 13 comprises a specified aperture diameter 131 ranging from 2 to 6 millimeters. In the preferred embodiment, the at least one magnet cavity 14 and the at least one magnet insert 15 comprises a specified magnet diameter 151 ranging from 8-12 millimeters. In the preferred embodiment, the at least one magnet cavity 14 and the at least one magnet insert 15 comprises a specified magnet thickness 152 ranging 1-3 millimeters. In the preferred embodiment, the at least one magnet insert 15 comprises a specified magnet power ranging from 35-52 megagauss-oesterds. In the preferred embodiment, the present invention is scaled to any suitable size such that the present invention installs along any suitable smoking device. In the preferred embodiment, the at least one mounting platform 12 is hexagonal in shape but may take the form of any other suitable shape such as but not limited to squares, circles, triangles, or any other suitable shape.

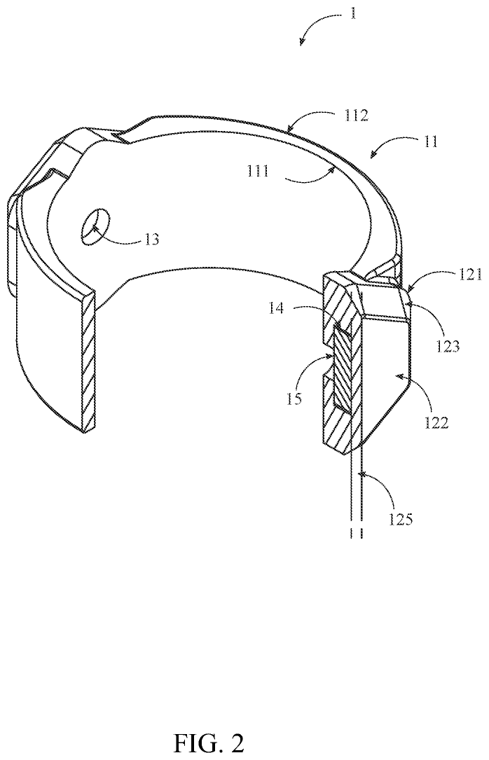

In reference to FIGS. 2-4, each of the at least one mounting platform 12 comprises a mounting body 121 and a mounting surface 122. The mounting body 121 traverses out from the exterior surface 112. The mounting surface 122 is positioned adjacent to the mounting body 121, opposite to the exterior surface 112. In the preferred embodiment, each of the at least one mounting platform 12 comprises a mounting body 121 and a mounting surface 122. The mounting body 121 traverses out from the exterior surface 112. The mounting surface 122 is positioned adjacent to the mounting body 121, opposite to the exterior surface 112. The mounting surface 122 is oriented parallel to the interior surface 111. The mounting body 121 is oriented perpendicular to the interior surface 111. The mounting surface 122 is oriented perpendicular to the mounting body 121. In the preferred embodiment, each of the at least one mounting platform 12 further comprises a beveled face 123, as shown in FIGS. 2-4. The beveled face 123 is positioned between the mounting body 121 and the mounting surface 122, where the beveled face 123 comprises a specified bevel angle 124 ranging from 0 to 90 degrees. In the preferred embodiment, each of the at least one mounting platform 12 further comprises an interior wall 125, as shown in FIGS. 2 and 4. In reference to FIG. 4, the interior wall 125 is positioned between the at least one magnet cavity 14 and the mounting surface 122, where the interior wall 125 comprises a specified wall thickness 126 ranging from 0.5 to 2.5 millimeters. In the preferred embodiment, the specified wall thickness 126 is scaled and optimized to offset the at least one magnet from the mounting surface 122 such that the holding power of the at least one mounting platform 12 is sufficient enough to hold the lighter, smoking device tool, or any other accessory along the smoking device.

In the preferred embodiment, the mounting body 121 takes the form of a raised mounting body 121 along the band body 11 that constitutes and positions the at least one magnet cavity 14, the at least one magnet insert 15, and the mounting surface 122 along the band body 11. In the preferred embodiment, the mounting surface 122 is a flat surface. Assuming the flat surface optimizes the surface area of the mounting surface 122 such that the lighter or any other suitable smoking device tool magnetically mounts along the mount surface. In conventional systems, the mounting surface 122 is often rounded, leading magnetically mounted smoking device accessories to roll or slip off.

Although the invention has been explained in relation to its preferred embodiment, it is to be understood that many other possible modifications and variations can be made without departing from the spirit and scope of the invention as hereinafter claimed.

What is claimed is:

1. A magnetic band for smoking device comprising:
a band body;
at least one mounting platform;
at least one magnet aperture;
at least one magnet cavity;
at least one magnet insert;
the band body comprising an interior surface and an exterior surface;
the at least one mounting platform being positioned adjacent to the exterior surface;
the at least one mounting platform being distributed about the exterior surface of the band body;
each of the at least one magnet cavity being positioned within each of the at least one mounting platform;
each of the at least one magnet aperture traversing from the band body to each of the at least one magnet cavity; and
each of the at least one magnet insert being positioned within each of the at least one magnet cavity, wherein each of the at least one magnet insert is configured to slip through each of the at least one magnet aperture and install along each of the at least one magnet cavity.

2. The magnetic band for smoking device as claimed in claim 1, comprising:
each of the at least one magnet aperture traversing from the interior surface to each of the at least one magnet cavity.

3. The magnetic band for smoking device as claimed in claim 1, comprising:
each of the at least one mounting platform comprising a mounting body and a mounting surface;
the mounting body traversing out from the exterior surface; and
the mounting surface being positioned adjacent to the mounting body, opposite to the exterior surface.

4. The magnetic band for smoking device as claimed in claim 3, comprising:
the mounting surface being oriented parallel to the interior surface.

5. The magnetic band for smoking device as claimed in claim 3, comprising:
the mounting body being oriented perpendicular to the interior surface.

6. The magnetic band for smoking device as claimed in claim 3, comprising:
the mounting surface being oriented perpendicular to the mounting body.

7. The magnetic band for smoking device as claimed in claim 1, comprising:
each of the at least one mounting platform comprising a mounting body and a mounting surface;
the mounting body traversing out from the exterior surface;
the mounting surface being positioned adjacent to the mounting body, opposite to the exterior surface;
the mounting surface being oriented parallel to the interior surface;
the mounting body being oriented perpendicular to the interior surface; and
the mounting surface being oriented perpendicular to the mounting body.

8. The magnetic band for smoking device as claimed in claim 1, comprising:
each of the at least one mounting platform comprising a mounting body, a mounting surface, and a beveled face;
the mounting body traversing out from the exterior surface;
the mounting surface being positioned adjacent to the mounting body, opposite to the exterior surface; and
the beveled face being positioned between the mounting body and the mounting surface, wherein the beveled face comprises a specified bevel angle ranging from 0 to 90 degrees.

9. The magnetic band for smoking device as claimed in claim 1, comprising:
each of the at least one mounting platform comprising a mounting body, an interior wall, and a mounting surface;
the mounting body traversing out from the exterior surface; and
the mounting surface being positioned adjacent to the mounting body, opposite to the exterior surface;
the interior wall being positioned between the at least one magnet cavity and the mounting surface, wherein the interior wall comprises a specified wall thickness ranging from 0.5 to 2.5 millimeters.

10. The magnetic band for smoking device as claimed in claim 1, wherein the at least one mounting platform is hexagonal in shape.

11. The magnetic band for smoking device as claimed in claim 1, wherein the band body and the at least one mounting platform are made out of an elastic material.

12. The magnetic band for smoking device as claimed in claim 1, wherein the band body and the at least one mounting platform are made out of an elastic material comprising a specified durometer hardness ranging from 30 to 50 shore A hardness.

13. The magnetic band for smoking device as claimed in claim 1, wherein the interior surface comprises a specified band inner diameter ranging from 20 to 45 millimeters.

14. The magnetic band for smoking device as claimed in claim 1, wherein the at least one magnet aperture comprises a specified aperture diameter ranging from 2 to 6 millimeters.

15. The magnetic band for smoking device as claimed in claim 1, wherein the at least one magnet insert comprises a specified magnet power ranging from 35-52 megagauss-oesterds.

16. The magnetic band for smoking device as claimed in claim 1, comprising:
each of the at least one mounting platform comprising a mounting body, an interior wall, and a mounting surface;
the at least one magnet insert comprises a specified magnet power ranging from 35-52 megagauss-oesterds.
the mounting body traversing out from the exterior surface;
the mounting surface being positioned adjacent to the mounting body, opposite to the exterior surface; and
the interior wall being positioned between the at least one magnet cavity and the mounting surface, wherein the interior wall comprises a specified wall thickness ranging from 0.5 to 2.5 millimeters.

17. The magnetic band for smoking device as claimed in claim 3, wherein the mounting surface is a flat surface.

18. A magnetic band for smoking device comprising:
a band body;
at least one mounting platform;
at least one magnet aperture;
at least one magnet cavity;
at least one magnet insert;
the band body comprising an interior surface and an exterior surface;
each of the at least one mounting platform comprising a mounting body and a mounting surface;
the at least one mounting platform being positioned adjacent to the exterior surface;
the at least one mounting platform being distributed about the exterior surface of the band body;
each of the at least one magnet cavity being positioned within each of the at least one mounting platform;
each of the at least one magnet aperture traversing from the band body to each of the at least one magnet cavity;
each of the at least one magnet insert being positioned within each of the at least one magnet cavity, wherein each of the at least one magnet insert is configured to slip through each of the at least one magnet aperture and install along each of the at least one magnet cavity;
the mounting body traversing out from the exterior surface; and
the mounting surface being positioned adjacent to the mounting body, opposite to the exterior surface.

19. A magnetic band for smoking device comprising:
a band body, wherein the band body is made out of an elastic material;
at least one mounting platform, wherein the band body is made out of an elastic material;
at least one magnet aperture;
at least one magnet cavity;
at least one magnet insert;
the band body comprising an interior surface and an exterior surface;
the at least one mounting platform being positioned adjacent to the exterior surface;
the at least one mounting platform being distributed about the exterior surface of the band body;
each of the at least one magnet cavity being positioned within each of the at least one mounting platform;
each of the at least one magnet aperture traversing from the band body to each of the at least one magnet cavity; and
each of the at least one magnet insert being positioned within each of the at least one magnet cavity, wherein each of the at least one magnet insert is configured to slip through each of the at least one magnet aperture and install along each of the at least one magnet cavity.
